(19) United States
(12) Patent Application Publication
(10) Pub. No.: US 2026/0291062 A1
(43) Pub. Date: Sep. 24, 2026

(54) ELECTROMAGNETIC METASURFACE FOR WIRELESS SIGNAL ENHANCEMENT

(71) Applicant: ZHEJIANG UNIVERSITY, Zhejiang (CN)

(72) Inventors: Bin ZHENG, Hangzhou (CN); Jiwei ZHAO, Hangzhou (CN); Huan LU, Hangzhou (CN); Rongrong ZHU, Hangzhou (CN); Peixuan ZHU, Hangzhou (CN); Zijun CHEN, Hangzhou (CN); Tong AN, Hangzhou (CN); Hongsheng CHEN, Hangzhou (CN)

(73) Assignee: ZHEJIANG UNIVERSITY, Zhejiang (CN)

(21) Appl. No.: 19/362,513

(22) Filed: Oct. 20, 2025

Related U.S. Application Data
(63) Continuation of application No. PCT/CN2025/088402, filed on Apr. 11, 2025.

(30) Foreign Application Priority Data
Dec. 17, 2024 (CN) 202411855657.6

(51) Int. Cl. H01Q 3/30; H01Q 21/00

(52) U.S. Cl. CPC H01Q 3/30; H01Q 21/00

(57) ABSTRACT

The provided is an electromagnetic metasurface for wireless signal enhancement. The electromagnetic metasurface includes a plurality of metallic grid units with equal side lengths and a flexible and transparent polyethylene terephthalate (PET) film substrate. Each metallic grid unit exhibits a square metallic structure centrally integrating a plurality of tunable metallic stubs. Variation of the structural side length and the length of the metallic stubs enables modulation of both the transmission phase and amplitude of incident electromagnetic waves. By respectively deploying the electromagnetic metasurface on both sides of a transparent glass substrate, the assembly formed by the electromagnetic metasurface and glass substrate is capable of macroscopically regulating the incident electromagnetic waves, thereby improving wireless signal coverage. The electromagnetic metasurface exhibits a visible light transmittance of exceeding 85%, covers a beam steering range exceeding −150° to 150°, and achieves a peak signal gain above 30 dB.

### CROSS-REFERENCE TO THE RELATED APPLICATIONS

This application is a continuation application of International Application No. PCT/CN2025/088402, filed on Apr. 11, 2025, which is based upon and claims priority to Chinese Patent Application No. 202411855657.6, filed on Dec. 17, 2024, the entire contents of which are incorporated herein by reference.

### TECHNICAL FIELD

The present disclosure relates to the technical field of electromagnetic wave manipulation, and more specifically, to an electromagnetic metasurface for wireless signal enhancement.

### BACKGROUND

With the rapid advancement of 5G communication technology, along with the diversification of service types and the continuous expansion of industry boundaries, the demand of users for wireless networks is undergoing a significant shift from outdoor to indoor environments. According to industry forecasts, in the context of the 5G era, the proportion of consumer-side mobile communication services in indoor environments is projected to substantially exceed 85%, highlighting the growing significance of indoor wireless network coverage.

However, the continuous evolution of wireless communication technologies, particularly the ongoing increase in the operating frequency of electromagnetic waves, presents unprecedented challenges to the coverage and penetration of electromagnetic signals. High-frequency band communication technologies, while pursuing higher performance, must overcome the challenges of electromagnetic signal propagation in complex environments. Particularly, how to achieve through-wall transmission and high-efficiency indoor penetration of millimeter waves has become a key technical issue that urgently needs to be resolved.

To address the aforementioned problem, a metamaterial-based planar transmission array with a subwavelength periodic structure has been developed. The novel material achieves the redirection of wireless signals towards a specific direction by precisely controlling the transmission path of electromagnetic waves, thereby effectively improving the coverage range and significantly enhancing the signal strength of the wireless network thereby effectively improving the coverage range of the wireless network and significantly enhancing the network signal strength. As a cost-effective and practical solution, the metasurface planar transmission array has demonstrated significant application potential in the field of wireless communications, providing robust technical support particularly for millimeter-wave through-wall transmission.

During the design of a planar transmission array, the following key requirements must be satisfied: first, the phase coverage of the array units should be as broad as possible to ensure omnidirectional signal transmission; second, the transmittance within the passband should be maximized to minimize signal loss; third, the passband bandwidth should be as broad as practicable to accommodate signal transmission requirements across varying frequencies; and fourth, the preparation process should be as simple as possible, so as to reduce production costs and improve production efficiency.

However, conventional transmissive metasurfaces with beam-steering capabilities still exhibit numerous structural drawbacks. To achieve full 360-degree phase coverage, most transmissive metasurfaces adopt a multi-layer stacked configuration, where air cavities with stringent dimensional tolerances may even be disposed between adjacent layers. The configuration not only compromises structural compactness but also imposes stringent fabrication tolerances and assembly alignment precision, thereby exacerbating calibration complexity. Furthermore, most transmission metasurfaces commonly employ PCB substrates as base materials, which lack optical transparency, thereby failing to satisfy application scenarios requiring optical clarity or visual observation.

Although a limited number of researchers have attempted to develop optically-transparent antennas by employing films with high optical transparency and transparent media (such as glass) as core materials, such approaches nonetheless face persistent challenges in practical applications. For example, the modification of conventional glass poses significant challenges in terms of difficulty and cost; moreover, the designed antenna often has a considerable thickness, presenting difficulties in achieving conformal deployment with actual scenarios. Accordingly, developing a transmissive metasurface that simultaneously exhibits superior beam-steering capability, high optical transparency, and a compact structural configuration has become a critical technical challenge urgently requiring resolution in the field of wireless communications.

### SUMMARY

In view of the foregoing, the present disclosure provides an electromagnetic metasurface for wireless signal enhancement, configured to exhibit superior beam-steering capability, high optical transparency, and a compact structural configuration.

To achieve the foregoing objective, the present disclosure adopts the following technical solutions.

An electromagnetic metasurface for wireless signal enhancement includes:
an array of N×M metasurface unit cells, wherein each metasurface unit cell includes a flexible substrate layer, and a metal grid layer attached to the flexible substrate layer;
the metal grid layer is a nano-copper metallic grid pattern, wherein a structure of the nano-copper metallic grid pattern includes a square metal frame and dual short stubs symmetrically disposed within the square metal frame; the nano-copper metallic grid pattern is partitioned into a square closed region divided into an upper portion and a lower portion respectively provided with dual short stubs and an intermediate region, and each metasurface array unit cell is configured to adjust a phase by modulating stub dimensions;
a design of the metasurface array unit cell includes:

determining material properties of a dielectric layer;
designing structural parameters of the metal grid layer based on the material properties of the dielectric layer, and determining an oscillation threshold of the nano-copper metallic grid pattern;
adjusting a side length w of the metasurface unit cell based on a center frequency point f of a frequency band in which a target signal is located, and further modifying structural parameters of the metasurface unit cell to enable the array of N×M metasurface unit cells to achieve linear phase-shifting characteristics, wherein the structural parameters of the metasurface unit cell include a line width and a short line length; and
determining, for an incident wave with an angle of incidence w, and given a predetermined beam direction θ, each unit structure of the metal grid layer.

Preferably, further including a dielectric layer, wherein the metasurface unit cells are disposed on the dielectric layer.

Preferably, to achieve signal enhancement at an angle θ, a phase distribution for an i-th column of unit cells is configured to satisfy:

$${θ}_{i} = - \frac{2 π fw}{c} i ( cos θ + cos ψ ) ;$$

wherein f represents a center frequency of an incident wave, c represents a propagation velocity of an electromagnetic wave, w represents a side length of each metasurface unit cell, and ψ represents an incidence angle of the incident wave.

Preferably, to simplify an overall design of the metamembrane, a phase θᵢ for each column of unit cells is quantized into four fixed unit structures, and transmission phases of the four fixed unit structures are respectively:

$$ϕ = \{ 0 , \frac{π}{2} , π , \frac{3 π}{2} \} .$$

Preferably, calculating a phase θᵢ for an i-th column of metasurface unit cells, then computing an index of a target structural unit from a structural parameter library:

$${arg min}_{j} \{ {θ}_{j} - {ϕ}_{j} \} ;$$

and

selecting a j-th unit structure as a standard configuration of the columnar metasurface. Preferably, a thickness of the metal grid layer ranges from 0.2 μm to 1 μm.

Preferably, a material of the flexible substrate layer is polyethylene terephthalate.

According to the above technical solutions, compared with the prior art, the present disclosure provides an electromagnetic metasurface for wireless signal enhancement. Through precise design and control of the pattern dimensions on the membrane, extensive and accurate phase control of electromagnetic waves is achieved. During experimental testing, the metasurface exhibits a transmission efficiency exceeding 85% over an operational frequency band from 5.2 GHz to 5.8 GHz, which is capable of effectively adjusting the deflection angle of the transmitted wave over a wide range from −150° to 150°, while achieving a peak gain exceeding 30 dB, thereby realizing a significant enhancement in signal strength. The metasurface array composed of the nano-copper electromagnetic metasurface provided by the present disclosure not only exhibits a broadband response capability, but also offers the dual advantages of high optical transparency and high transmittance, capable of being flexibly deployed in multiple substrates requiring preservation of optical transparency or transparent viewing functionality, including, but not limited to, building windows and vehicle windshields. Thereby, without compromising visual clarity or aesthetic integrity, the coverage and transmission quality of wireless signals are effectively improved without affecting visibility and aesthetics.

### BRIEF DESCRIPTION OF THE DRAWINGS

In order to describe the technical solutions in the embodiments of the present disclosure more clearly, the accompanying drawings required to describe the embodiments are briefly described below. Apparently, the accompanying drawings described below are only some embodiments of the present disclosure. Those of ordinary skill in the art may further obtain other accompanying drawings based on these accompanying drawings without creative efforts.

FIG. 1 is a perspective view of a basic unit cell structure of an electromagnetic metasurface with a nano-copper structure according to the present disclosure;

FIG. 2 is a schematic diagram of one embodiment of an electromagnetic metasurface based on a transparent metallic grid pattern according to the present disclosure;

FIG. 3 is a schematic diagram of a unit metallic trace pattern of a transparent metallic grid pattern according to the present disclosure;

FIG. 4 illustrates a schematic diagram of a principle for generating a geometric phase according to the present disclosure;

FIG. 5 is a flowchart illustrating an exemplary embodiment of a phase modulation method based on an electromagnetic metasurface according to the present disclosure;

FIG. 6 illustrates a process for individually modulating a phase of incident electromagnetic waves by each of N×M array units in an electromagnetic metasurface according to the present disclosure; and

FIG. 7 illustrates simulated focusing results of a high-gain electromagnetic metasurface according to the disclosure.

### DETAILED DESCRIPTION OF THE EMBODIMENTS

In the following, the technical solutions in the embodiment of the disclosure will be clearly and completely described in combination with the accompanying drawing in the embodiment of the present disclosure. Apparently, the described embodiments are merely a part of the embodiments of the present disclosure, but not all of the embodiments thereof. Based on the embodiments of the present disclosure, all other embodiments obtained by those of ordinary skill in the art without creative efforts shall fall within the protection scope of the present disclosure.

The present disclosure provides an electromagnetic metasurface for wireless signal enhancement. In the present disclosure, a nano-copper electromagnetic metasurface is formed by sequentially arranging a metallic grid pattern and a flexible PET substrate. In practical applications, the nano-copper electromagnetic metasurface is deployed on a transparent glass plate that carries the metasurface. After formation of the transmission array, the phase of the incident electromagnetic waves is modulated, such that a predetermined phase distribution is achieved after beamforming, thereby achieving high optical transparency while enabling high-gain beam focusing and steering of electromagnetic waves, thus significantly enhancing three-dimensional spatial coverage of electromagnetic signal propagation.

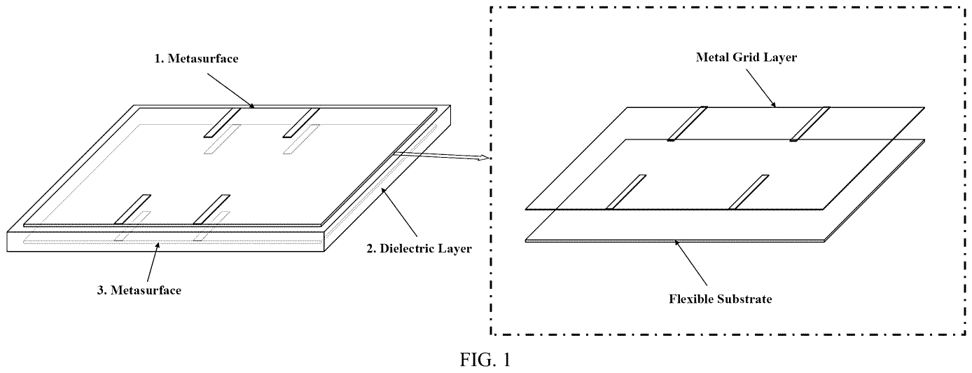

An embodiment of the present disclosure discloses an electromagnetic metasurface for wireless signal enhancement, as shown in FIG. 1, including:

an array of N×M metasurface unit cells, wherein each metasurface unit cell includes a flexible substrate layer, and a metal grid layer attached to the flexible substrate layer. The flexible substrate layer and the metal grid layer possess optical transparency, thereby constituting a transparent nano-copper electromagnetic metasurface; and in practical applications, the nano-copper electromagnetic metasurface is deployed on both sides of a transparent glass panel.

When incident electromagnetic waves imping on a high-gain electromagnetic metasurface based on a nano-copper structure at a certain angle, the phase of the incident electromagnetic waves is modulated by a corresponding number of array units, to achieve a predetermined phase distribution, thus, a transmitted electromagnetic wave is achieved with functionalities such as broadband operation, high transmittance, and optical transparency, furthermore, high-gain beam focusing and steering is implemented on the incident electromagnetic waves to enhance both penetration depth and spatial coverage of electromagnetic signals.

Wherein the metasurface array unit cell exhibits high transmission efficiency and a transmissive phase. The metallic grid pattern is formed on the transparent flexible substrate layer by a process selected from the group consisting of: etching, photolithography, electroless plating, and electroplating. A transmissive array is constructed by sequentially disposing the metallic grid pattern layer and the flexible substrate layer, whereby transmission phase modulation and beam control of the incident electromagnetic waves are achieved.

In the electromagnetic metasurface according to the embodiment of the present disclosure, beam-steering capability and visible light transparency of the electromagnetic control are simultaneously achieved by utilizing a film comprising the transparent flexible PET substrate and the nano-copper metallic grid pattern. Namely, by replacing the conventional thick and opaque transmissive metasurface with an ultra-thin, transparent, and flexible PET substrate and a nano-copper metallic grid structure, the present disclosure achieves visual transparency in the electromagnetic metasurface, thereby enabling the electromagnetic metasurface to exhibit conformable optical transparency, allowing application in scenarios requiring optical transparency or visual observation, including but not limited to interior and exterior glazed curtain walls of urban buildings and windows of large transportation vehicles, for providing high-quality communication services to a large number of mobile terminal devices whilst fulfilling requirements for optical transparency.

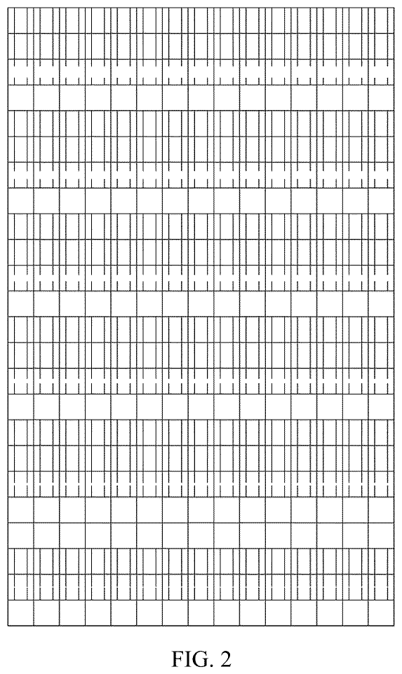

FIG. 2 illustrates one embodiment of a transparent antenna array formed by configuring an array of N×M unit cells in a predetermined manner based on an electromagnetic metasurface with a transparent metallic grid pattern.

Specifically, given a target phase distribution (a predetermined phase distribution) for the shaped incident electromagnetic waves, the length dimensions of the dual short stubs in the metallic pattern of the array of N×M unit cells are controlled in accordance with all pixel points in a predetermined phase distribution, such that the deployed array of N×M unit cells transmits the electromagnetic wave, thereby achieving a predetermined phase distribution. FIG. 4 illustrates a schematic diagram of a principle for generating a geometric phase.

For example, when an electromagnetic wave is incident normally on a metasurface, the electromagnetic wave's wavefront (i.e., an equiphase surface) propagates through a transparent antenna array constituted by the array of N×M unit cells. Wherein a locally discretized phase at a respective position is regulated by each array unit, such that following phase modulation conducted through N×M meta-atoms on the transparent antenna array, a phase distribution constituted by N×M localized phases is formed. A metasurface fabricated in accordance with the new phase distribution corresponds to electromagnetic metasurface for wireless signal enhancement disclosed in the present disclosure.

In the present disclosure, through dimensional control of patterns, the electromagnetic metasurface is configured to perform high-gain beam focusing and steering on transmitted electromagnetic waves, thereby enabling functionalities including but not limited to beam scanning, multi-beam generation, and vortex field formation. A multifunctional high-gain electromagnetic metasurface is realized, which is conformally deployed on substrates requiring optical transparency or transparent viewing functionality, including, but not limited to, building surfaces or vehicle surfaces. The electromagnetic metasurface, which is configured to be deposited on conventional window glass, exhibits high optical transmittance while performing high-gain beam focusing and steering on incident electromagnetic waves, thus effectively increasing the penetration depth and spatial coverage of the electromagnetic signals.

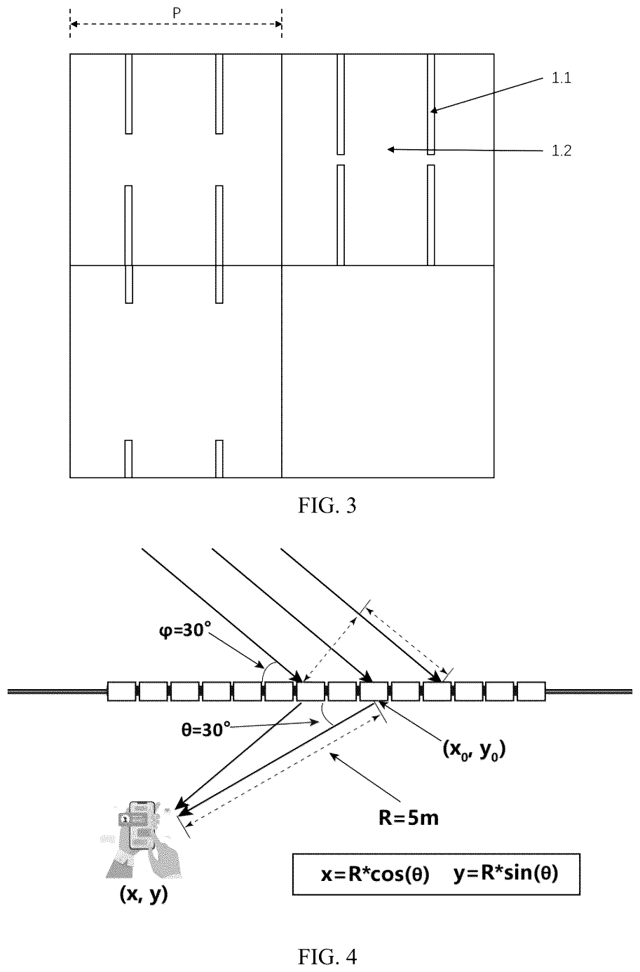

Specifically, the metallic grid pattern layer is partitioned into a square closed region with dual short stubs disposed at upper and lower portions thereof and an intermediate region, and each metasurface array unit cell is configured to adjust a phase by modulating stub dimensions. As depicted in FIG. 3, each array unit includes metallic trace patterns configured in a square geometry, length and width dimensions of the array unit are equal to a pitch dimension P, A transparent nano-copper metallic grid pattern layer includes a square metallic trace pattern with dual short stubs disposed at upper and lower portions thereof, the square closed region 1.1 is a metallic region, and the central region 1.2 is an aperture region. The square metallic trace pattern with dual short stubs disposed at upper and lower portions thereof according to the present disclosure achieves an ultra-low metallic duty ratio, thereby providing high transmittance of visible light, while simultaneously realizing broadband electromagnetic wave transmission with high amplitude response.

Specifically, all of the square metallic trace pattern layers with dual short stubs disposed at upper and lower portions thereof exhibit identical specifications, and all of the metallic pattern layers share identical thickness, shape, and external dimensions.

Further, the metasurface array unit cell in the embodiment of the present disclosure includes four fixed unit structures, with transmission phases of 0°, 90°, 180°, and 270°, respectively.

Furthermore, the metallic grid pattern layer exhibits a thickness of 0.2-1 μm, a sheet resistance less than or equal to 0.06 Ω/sq, and includes nanoscale copper formed by a nano-fabrication process. By controlling the thickness of the transparent metallic grid structure within a range of 0.2 to 1 μm, electrical connection stability and signal sensitivity between unit patterns of the transparent metallic grid structure may be ensured, while avoiding excessive thickness of the transparent metallic grid structure, thereby facilitating the realization of a thin, lightweight, and conformal design for the electromagnetic metasurface. Due to the low sheet resistance of the nano-copper metallic grid structure employed in the electromagnetic metasurface of the present disclosure, the transparent metasurface unit cell structure may exhibit reduced electrical resistance, thereby improving electrical conductivity and signal sensitivity, and facilitating practical application.

In another embodiment, a material of the flexible substrate layer is polyethylene terephthalate.

In another embodiment, the flexible substrate layer exhibits a thickness of 100 μm. By controlling a thickness of the flexible transparent substrate within a range of 95-105 μm, sufficient structural integrity is ensured to support the transparent metallic grid pattern layer. Concurrently, excessive thickness is avoided, thereby facilitating lightweight and conformal integration of the electromagnetic ultra-transparent film.

In another aspect, an embodiment of the present disclosure further provides a method for fabricating the electromagnetic metasurface for wireless signal enhancement, and the method includes:
material properties of a target dielectric medium are tested, and the material properties include thickness and dielectric constant;
a metallic structural layer is determined in accordance with metasurface design methodology;
a metasurface is fabricated in accordance with metallic structural layer parameters;
and

the metasurface is attached to the target dielectric layer, whereby signal enhancement over a specified angular domain is achieved.

A design of the metasurface array unit cell includes:
material properties of a dielectric layer are determined;
structural parameters of the metal grid layer are designed based on the material properties of the dielectric layer, and an oscillation threshold of the nano-copper metallic grid pattern is determined;
a side length w of the metasurface unit cell is adjusted based on a center frequency point f of a frequency band in which a target signal is located, and structural parameters of the metasurface unit cell are further modified to enable the array of N×M metasurface unit cells to achieve linear phase-shifting characteristics, wherein the structural parameters of the metasurface unit cell include a line width and a short line length; and
for an incident wave with an angle of incidence w, and given a predetermined beam direction θ, each unit structure of the metal grid layer is determined.

To achieve signal enhancement at an angle θ, a phase distribution for an i-th column of unit cells is configured to satisfy:

$${θ}_{i} = - \frac{2 π fw}{c} i ( cos θ + cos ψ ) ;$$

wherein f represents a center frequency of an incident wave, c represents a propagation velocity of an electromagnetic wave, w represents a side length of each metasurface unit cell, and ψ represents an incidence angle of the incident wave.

To simplify an overall design of the metamembrane, a phase θᵢ for each column of unit cells is quantized into four fixed unit structures, wherein transmission phases thereof are respectively:

$$ϕ = \{ 0 , \frac{π}{2} , π , \frac{3 π}{2} \} .$$

a phase θᵢ for an i-th column of metasurface unit cells is calculated, then an index of a target structural unit is computed from a structural parameter library:

$${arg min}_{j} \{ {θ}_{j} - {ϕ}_{j} \} ;$$

and a j-th unit structure is selected as a standard configuration of the columnar metasurface.

Further, as illustrated in FIG. 6, a method of fabricating a transparent antenna array based on the electromagnetic metasurface includes the following steps:

S100. An antenna array is obtained by configuring an array of N×M unit cells in accordance with a predetermined scheme.

Specifically, to achieve beam focusing and steering of electromagnetic waves utilizing the electromagnetic metasurface, initially, N×M meta-atoms are arranged in a predetermined spatial distribution to form a transparent antenna array, whereby beam focusing of the electromagnetic waves is performed by the transparent antenna array.

Furthermore, in S100, the step of obtaining the transparent antenna array from the array of N×M unit cells in the predetermined pattern specifically includes: dimensional parameters of dual short stubs in the array of N×M unit cells are differentially modulated according to respective phase points in a predetermined phase distribution, thereby obtaining the transparent antenna array.

Specifically, to achieve beam focusing and steering of electromagnetic waves utilizing the electromagnetic metasurface, initially, a required phase distribution is predetermined as a target phase profile, according to phase points specified in the target phase profile, dimensional parameters of dual short stubs are individually modulated for each of the array of N×M unit cells. Based on the required phase modulation degree for each phase point and the functional relationship between the modulation degree and the modulation dimension, a corresponding dimension is modulated for each array unit, thereby obtaining a customized glass array.

To achieve the beam focusing function, according to Huygens' principle (which states that every point on a spherical wavefront (treated as a surface source) serves as a secondary source of spherical wavelets, secondary wavelets exhibit wave velocity and frequency identical to wave velocity and frequency of the primary wave, whereby an envelope surface formed by secondary wavefronts at any given time instant constitutes a resultant wavefront of propagating radiation, and to achieve lens focusing, the total phase accumulated by the spherical wave that is emitted from each secondary wave source on the incident wavefront and then passes through the lens to the focal point must be equal), the phase distribution to be modulated across the entire planar glass array shall satisfy the following profile:

$${θ}_{i} = - \frac{2 π fw}{c} i ( cos θ + cos ψ ) ;$$

wherein f represents a center frequency of an incident wave, c represents a propagation velocity of an electromagnetic wave, w represents a side length of each metasurface unit cell, and ψ represents an incidence angle of the incident wave.

S200. Phase distribution: the electromagnetic metasurface modulates the phase of incident electromagnetic waves to obtain a predetermined phase distribution

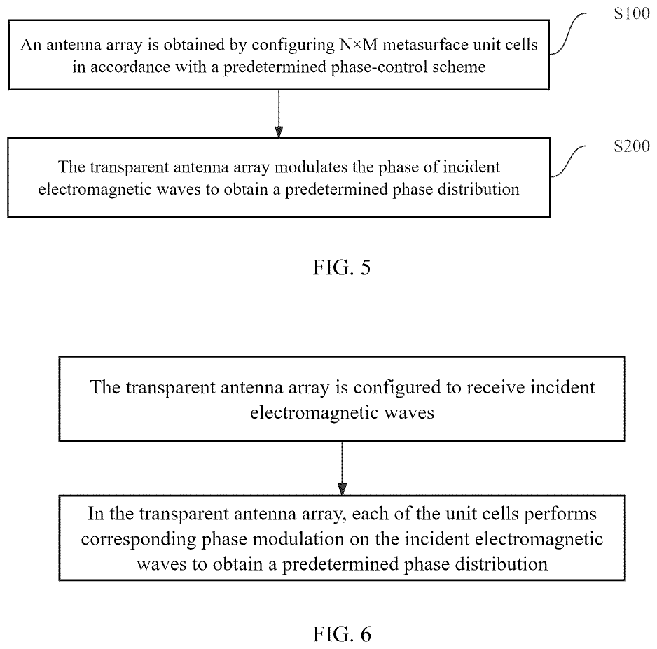

As shown in FIG. 5, after the electromagnetic metasurface is fabricated, the phase of the incident electromagnetic waves are modulated by the array of N×M unit cells within the electromagnetic metasurface. Then, the predetermined phase distribution is obtained through beamforming, whereby the phase of the incident electromagnetic waves is modulated by the transparent antenna array embedded therein, thereby achieving the predetermined phase distribution.

For example, when a plane wave is incident upon the transparent antenna array formed by the array of N×M unit cells, each unit cell is configured to modulate the local phase within an adjacent spatial region thereof (by discretely modulating). Then, after modulation by the array of N×M unit cells on the transparent antenna array, a new phase distribution (the predetermined phase distribution) including N×M discrete localized phases is formed, thereby achieving the predetermined phase distribution.

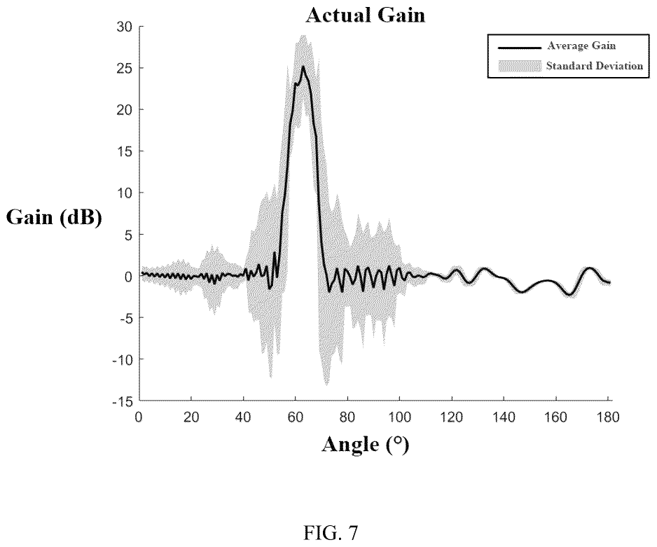

Further, referring to FIG. 7, a beam steering simulation is performed on a high-gain electromagnetic metasurface (based on phase modulation by the electromagnetic metasurface), thereby obtaining a resultant diagram of the simulated beam for the high-gain electromagnetic metasurface. The electromagnetic metasurface formed by the array of N×M unit cells is operated at an incident angle of 30°, and a deflection of transmitted waves by 60° with an angle gain of no less than 25 dB is achieved within an operating frequency band from 5.2 GHz to 5.8 GHz. Wherein, solid curves denote an average gain, while shaded areas represent standard deviations of corresponding angular gains.

In summary, the present disclosure provides a high-gain electromagnetic metasurface based on a nano-copper structure and a manufacturing method thereof. The electromagnetic metasurface includes a transparent substrate and a transparent metallic grid film. The transparent metallic grid film is formed by a plurality of arrayed units, including a transparent flexible substrate made of polyethylene terephthalate (PET) and a transparent metallic grid pattern formed on the PET substrate, where the grid pattern is configured as a square pattern with two short stubs disposed at upper and lower portions thereof, and each array unit is configured to regulate the phase by adjusting the stub dimensions. The transparent metallic grid pattern exhibits a sheet resistance less than or equal to 0.06 Ω/sq, and the transparent flexible PET substrate is disposed on a transparent substrate. A transmission array is formed by sequentially arranging a first transparent metallic grid pattern layer, a second transparent flexible PET substrate layer, and a third transparent substrate layer, whereby incident electromagnetic waves are phase-modulated and beam-controlled, thereby enhancing the spatial coverage of electromagnetic signals and enabling beamforming. The electromagnetic metasurface provided by the present disclosure enables a wide-range phase modulation by varying the design dimensions of the pattern. Additionally, in the operating frequency band of 5.2-5.8 GHz, the transmission amplitude is consistently above-1 dB, achieving a 60° deflection of the transmitted wave with an angular gain of 30 dB, wherein the metallic line width is merely 20 μm. The electromagnetic metasurface enables the array constructed therefrom to possess advantages including a wide passband, favorable optical transparency, high transmission rate, and facile manufacturability, and is deployable in scenarios requiring optical transparency or perspective observation, such as windows of buildings or vehicles.

Various embodiments of the present specification are described in a progressive manner, and each embodiment focuses on the description that is different from the other embodiments, and the same or similar parts between the various embodiments are referred to with each other. For the device disclosed by the embodiment, the description is relatively simple because it corresponds to the method disclosed by the embodiment, and the relevant information can be referred to the method section.

The above description of the disclosed embodiments enables those skilled in the art to implement or use the present disclosure. Various amendments to the embodiments will be apparent to those skilled in the art. The general principles defined herein may be implemented in other embodiments without departing from the spirit or scope of the disclosure. Therefore, the present disclosure will not be limited to the embodiments shown herein but is to be accorded the widest scope consistent with the principles and novel features disclosed herein.

What is claimed is:

1. An electromagnetic metasurface for wireless signal enhancement, comprising:
an array of N×M metasurface unit cells, each metasurface unit cell comprising a flexible substrate layer, and a metal grid layer attached to the flexible substrate layer;
a dielectric layer, wherein the metasurface unit cells are attached to the dielectric layer;
wherein the metal grid layer is a nano-copper metallic grid pattern, wherein a structure of the nano-copper metallic grid pattern comprises a square metal frame and dual short stubs symmetrically disposed within the square metal frame; the nano-copper metallic grid pattern is partitioned into a square closed region divided into an upper portion and a lower portion respectively provided with dual short stubs and an intermediate region, and each metasurface array unit cell is configured to adjust a phase by modulating stub dimensions;
a design of the metasurface array unit cell comprises:
determining material properties of a dielectric layer;
designing structural parameters of the metal grid layer based on the material properties of the dielectric layer, and determining an oscillation threshold of the nano-copper metallic grid pattern;
adjusting a side length w of the metasurface unit cell based on a center frequency point f of a frequency band where a target signal is located, and further modifying structural parameters of the metasurface unit cell to enable the array of N×M metasurface unit cells to achieve linear phase-shifting characteristics, wherein the structural parameters of the metasurface unit cell comprise a line width and a short line length; and
determining, for an incident wave with an angle of incidence w, and given a predetermined beam direction θ, each unit structure of the metal grid layer.

2. The electromagnetic metasurface for the wireless signal enhancement according to claim 1, wherein to achieve signal enhancement at an angle θ, a phase distribution for an i-th column of unit cells is configured to satisfy:
$${θ}_{i} = - \frac{2 π fw}{c} i ( cos θ + cos ψ ) ;$$
wherein f represents a center frequency of an incident wave, c represents a propagation velocity of an electromagnetic wave, w represents a side length of each metasurface unit cell, and ψ represents an incidence angle of the incident wave.

3. The electromagnetic metasurface for the wireless signal enhancement according to claim 1, wherein to simplify an overall design of a metamembrane, a phase θᵢ for each column of unit cells is quantized into four fixed unit structures, and transmission phases of the four fixed unit structures are respectively:
$$ϕ = \{ 0 , \frac{π}{2} , π , \frac{3 π}{2} \} .$$

4. The electromagnetic metasurface for the wireless signal enhancement according to claim 1, wherein calculating a phase θᵢ for an i-th column of metasurface unit cells, and computing an index of a target structural unit from a structural parameter library:
$${arg min}_{j} \{ {θ}_{j} - {ϕ}_{j} \} ;$$
and
selecting a j-th unit structure as a standard configuration of a columnar metasurface.

5. The electromagnetic metasurface for the wireless signal enhancement according to claim 1, wherein a thickness of the metal grid layer ranges from 0.2 μm to 1 μm.

6. The electromagnetic metasurface for the wireless signal enhancement according to claim 1, wherein a material of the flexible substrate layer is polyethylene terephthalate.
